(19) United States
(12) Patent Application Publication
(10) Pub. No.: US 2012/0163347 A1
(43) Pub. Date: Jun. 28, 2012

(54) APPARATUS AND METHOD FOR ALLOCATING SYNCHRONOUS TIME SLOT FOR LOW-POWER WIRELESS PERSONAL AREA NETWORK

(76) Inventor: Seong Soon JOO, Daejeon (KR)

(21) Appl. No.: 13/329,818

(22) Filed: Dec. 19, 2011

(30) Foreign Application Priority Data
Dec. 23, 2010 (KR) 10-2010-0133105

(51) Int. Cl. H04J 3/00; H04W 72/04

(52) U.S. Cl. 370/336

(57) ABSTRACT

Provided is an apparatus and method for allocating a synchronous time slot of a low-power wireless personal area network (WPAN) that allocates and controls a time slot based on synchronization in the low-power WPAN. A method of allocating a time slot by a communication node may minimize energy consumption and processing load associated with a message exchange since access to and release from a network may be possible without exchanging a message for controlling access between a coordinator and a device, may access a device in motion within a coordinator region by minimizing accessing time, and may enhance utilization of a time slot by optimally distributing links for accessing devices to available time slots uniformly using information of device global IDs.

### CROSS-REFERENCE TO RELATED APPLICATION

This application claims the priority benefit of Korean Patent Application No. 10-2010-0133105, filed on Dec. 23, 2010, in the Korean Intellectual Property Office, the disclosure of which is incorporated herein by reference.

### BACKGROUND

1. Field of the Invention

The present invention relates to an apparatus and method for allocating a synchronous time slot of a low-power wireless personal area network (WPAN) that allocates and controls a time slot based on synchronization in the low-power WPAN.

2. Description of the Related Art

In general, a communication system of a low-power wireless personal area network (WPAN) may perform an operation of controlling a connection to configure a network between a coordinator and a device. The operation of controlling a connection may include a radio link resource management, an allocation of a resource between devices associated with a contentious acquisition of a resource, and a release of a resource.

FIG. 1 illustrates a process of controlling a connection to a communication node in a low-power WPAN according to a related art.

Referring to FIG. 1, in response to a selection of a coordinator from among distributed devices, a connection to devices within a wireless range is performed with the selected coordinator as a center, and then a connection to a communication node within a sub-region is performed. Communication nodes within an area may contentiously acquire a resource of a wireless network, and communication nodes within a region i may be aware of a point in time of attempting communication of communication nodes within a region i+1 to avoid interference during communication.

Here, a scheme of dividing resources to allocate to each communication node in a time space may be used as a scheme of avoiding signal interference of a communication node.

FIG. 2 is a diagram illustrating a configuration of a wireless signal of associated with a scheme of allocating a synchronous time slot based on a beacon in a communication system of a low-power WPAN according to a related art.

For example, a scheme of allocating a synchronous time slot may configure a super-frame for a time slot using a beacon, a management time slot, a unidirectional time slot, and a bidirectional time slot.

FIG. 3 is a diagram illustrating a communication node accessing a network, moving through the network, and released from the network in a low-power WPAN according to a related art.

Referring to FIG. 3, after a wireless network is configured, a connecting operation for allocating a time slot may use an apparatus and method for allocating a time slot to a communication node that moves slowly and stays for a short time in a wireless network region and taking back the allocated time slot in a simple manner, in addition to allocating a time slot to a stationary communication node. That is, an apparatus and method for allocating a time slot that allocates a time slot to a communication node moving into a wireless network region, takes a time slot back from a communication node leaving the wireless network region, and allocates a time slot to a communication node passing through the wireless network region and staying in the region for a predetermined period of time and then takes back the allocated time slot from the time slot.

### SUMMARY

An aspect of the present invention provides an apparatus and method for allocating a synchronous time slot of a low-power wireless personal area network (WPAN) that controls a connection to a communication node in a communication system of the low-power WPAN using a synchronous time slot based on a beacon.

According to an aspect of the present invention, there is provided a coordinator including a scanner to scan a time slot in response to an occurrence of a beacon, thereby generating a bitmap related to use or non-use of the time slot, an update unit configured to classify the time slot as a non-occupation group and update a number of occupied time slots associated with the non-occupation group when the bitmap related to non-use is generated successively within a predetermined period of time, and a transmitter to broadcast, to a to communication node, information that is for allocating a time slot and includes the updated number of occupied time slots.

According to another aspect of the present invention, there is provided a communication node including a connector to connect to a communication node moving into a coordinator region by performing an operation of receiving a beacon during a predetermined collection time, and a controller to transmit a data frame to the communication node, and to control the connector to maintain the connection when the communication node permits reception of the transmitted data frame or to release the connection when the communication node rejects reception of the transmitted data frame.

According to an aspect of the present invention, there is provided an operating method, the method including scanning, by a coordinator, a time slot in response to an occurrence of a beacon, thereby generating a bitmap related to use or non-use of the time slot, classifying the time slot as a non-occupation group and updating a number of occupied time slots associated with the non-occupation group when the bitmap related to non-use is generated successively within a predetermined period of time, and broadcasting, to a communication node, information that is for allocating a time slot and includes the updated number of occupied time slots.

According to an aspect of the present invention, there is provided an operating method, the method including receiving, by a communication node, a beacon during a predetermined collection time, determining candidates for a time slot to be used based on information that is for allocating a time slot and is included in the collected beacon, attempting to transmit, to each time slot included in the determined candidates, a data frame based on an order of priority, and connecting to a time slot receiving the data frame via a network.

According to an aspect of the present invention, there is provided a method of allocating a time slot by a communication node that may minimize energy consumption and processing load associated with a message exchange since access to and release from a network may be possible without exchanging messages for controlling access between a coordinator and a device, may access a device in motion within a coordinator region by minimizing accessing time, and may enhance utilization of a time slot by optimally distributing links for accessing devices to available time slots uniformly, using information of device global IDs.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a hierarchical configuration of communication nodes in a low-power wireless personal area network (WPAN) according to a related art;

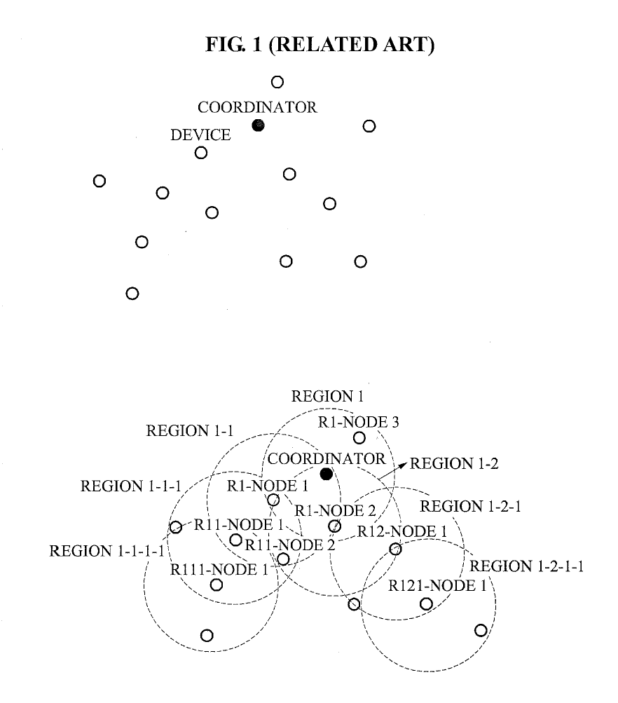

FIG. 2 is a diagram illustrating a configuration of a wireless signal of associated with a scheme of allocating a synchronous time slot based on a beacon in a communication system of a low-power WPAN according to a related art;

FIG. 3 is a diagram illustrating a communication node accessing a network, moving via the network, and released from the network in a low-power WPAN according to a related art;

FIG. 4 is a diagram illustrating a configuration of an apparatus for allocating a synchronous time slot of a low-power WPAN according to an embodiment of the present invention;

FIG. 5 is a flowchart illustrating an operational flow of a method of allocating a synchronous time slot of a low-power WPAN according to another embodiment of the present invention; and

FIG. 6 is a diagram illustrating an operation of a communication node that searches for a beacon and selects candidates for a time slot according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

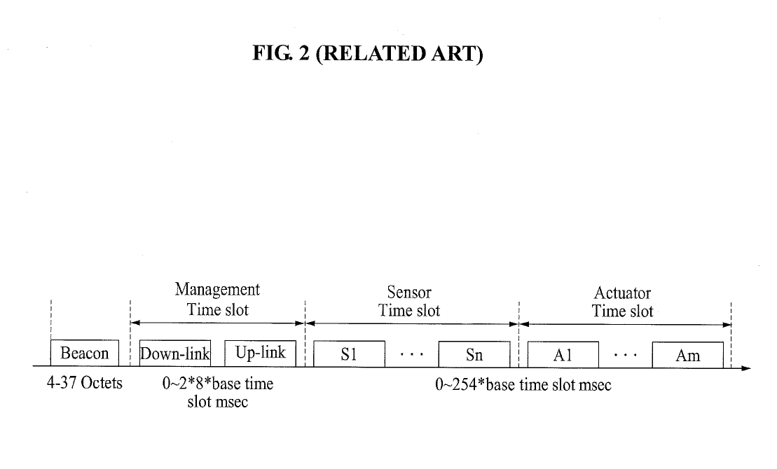

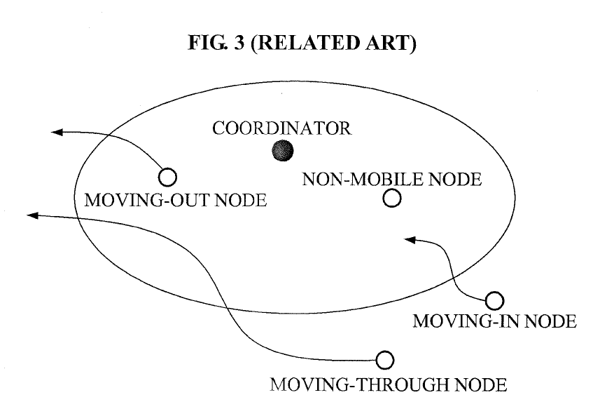

FIG. 2 illustrates a configuration of a wireless signal in a communication system of a low-power wireless personal area network (WPAN) using a synchronous time slot based on a beacon according to an embodiment of the present invention. FIG. 3 is a diagram illustrating a communication node accessing a network, moving via the network, and released from the network in a low-power WPAN according to a related art;

An access to and release from a network may be promptly performed for a communication node without a process of controlling a network configuration when the communication node stays in the network for a relatively short period of time and moves out of the network as illustrated in FIG. 3 in a wireless network where access to a time slot based on synchronization is performed as illustrated in FIG. 2. Thus, a time slot may be allocated and released without a controlling process, and an apparatus and method may be used to receive an allocation of a time slot without using a control message.

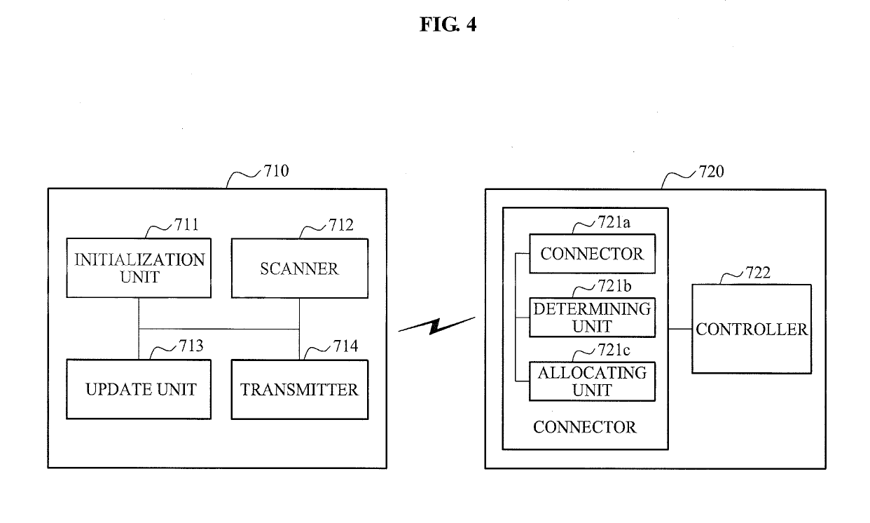

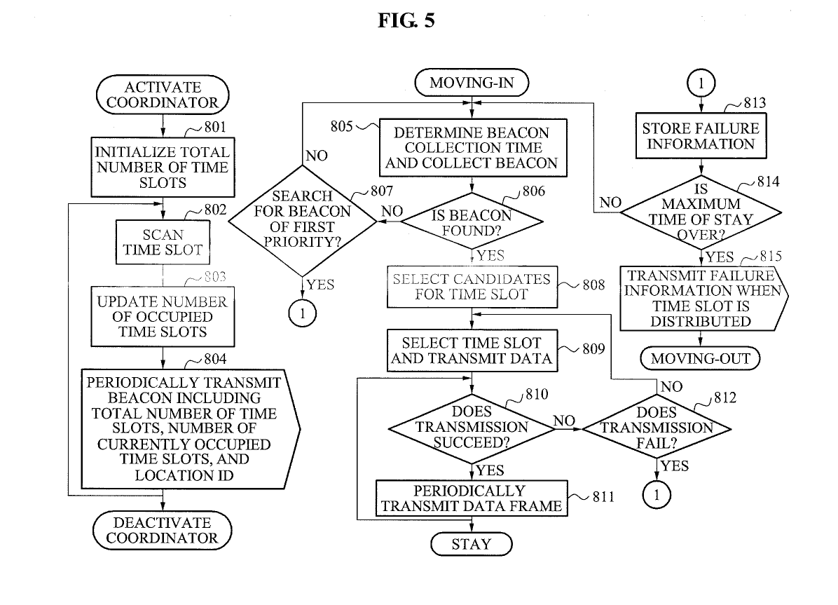

FIG. 4 illustrates a configuration of an apparatus for allocating a synchronous time slot of a low-power WPAN according to an embodiment of the present invention, and FIG. 5 illustrates a method of allocating a synchronous time slot of a low-power WPAN according to an embodiment of the present invention.

Referring to FIG. 4, a coordinator 710 may include an initialization unit 711 configured to reserve, at a predetermined value, a total number of time slots when the time slot is initialized, a scanner 712 to scan a time slot for each beacon, thereby generating a bitmap related to use or non-use of the time slot, an update unit 713 configured to exclude the time slot from occupied time slots and update a number of occupied time slots when the time slot remains unused for more than a predetermined period of time, and a transmitter 714 to maintain information for allocating a time slot by including, in a beacon, a total number of time slots, a number of currently occupied time slots, and information for identifying a location of a current coordinator, and broadcasting the beacon.

A communication node 720 may include a connector 721 to connect to a communication node moving into a coordinator region, and a controller 722 to maintain a connection to communication node within a coordinator region, and release a connection to a communication node leaving the coordinator region. The connector 721 may include a collector 721a to collect a beacon, a determining unit 721b configured to determine candidates for a time slot to be used based on information that is for allocating a time slot and is included in the collected beacon, and an allocating unit 721c configured to allocate a time slot in an order of priority from among the candidates for a time slot.

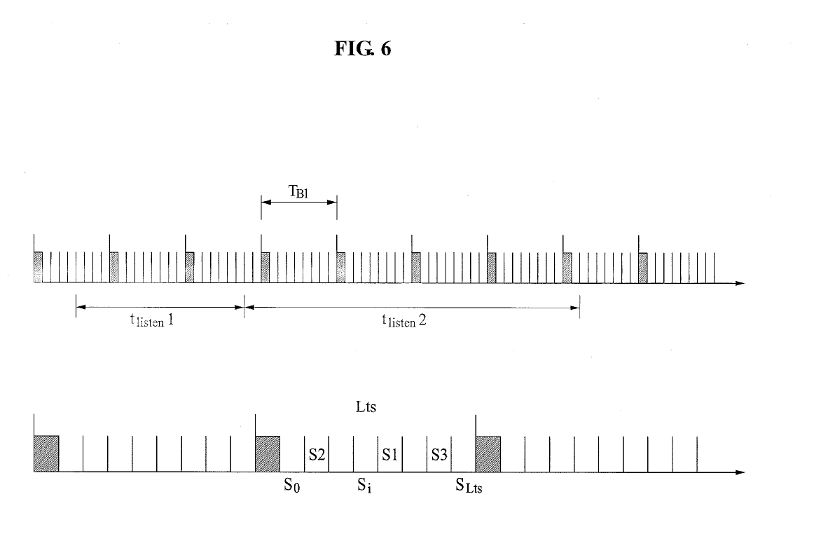

The communication node 720 may designate an identifier that is unique in a wide range within an area using a service. FIG. 6 illustrates an example of controlling a connection to the communication node 720 of a communication system in a low-power WPAN using a synchronous time slot based on a beacon.

The coordinator 710 may repeatedly transmit beacons in a time interval T_{BI}. A beacon may include location information ZID of a coordinator, information of a total number of time slots Lts and a number of currently used time slots 0ts.

The collector 721a may perform a scheme of increasing time intervals for collecting beacon information based on whether a communication node receives a beacon. An example of determining time for collecting a beacon by the collector 721a is as follows.

Referring to FIG. 6, the collector 721a may perform an operation of receiving a beacon during a time interval tₗᵢₛₜₑₙ. The time interval tₗᵢₛₜₑₙ corresponds to two times a value obtained by multiplying a length of a time slot by a maximum number of time slots provided by a wireless network. The collector 721a may collect a beacon twice during the time interval tₗᵢₛₜₑₙ when no beacon exists, may collect a beacon during four times the time interval tₗᵢₛₜₑₙ when a beacon remains impossible to be collected, and may suspend a reception during a time interval tₛₗₑₑₚ and then continue to collect a beacon when a beacon remains impossible to be collected. When multiple beacons are collected, the collector 721a may select a beacon having a highest priority for location information.

The determining unit 721b may select time slots as a first, second, and third priority of candidates using a hash function based on an identifier to determine candidates for a time slot to be used, and may increase a number of hash functions and candidates for a time slot, as necessary. When the identifier corresponds to a resident registration number, the determining unit 721b may determine a location of a time slot of a communication node corresponding to an identifier IDi to be s1=IDi mod Lts when the time slot corresponds to the first priority, s2=(IDi*IDi) mod Lts when the time slot corresponds to the second priority, and s3=(IDi*IDi*IDi) mod Lts when the time slot corresponds to the third priority.

When the allocating unit 721c finds a beacon, it may verify candidates for a time slot to be used during a single beacon interval, and select and use a time slot as per priority from among vacant time slots.

FIG. 5 is a flowchart illustrating an operational flow of a method of allocating a synchronous time slot of a low-power WPAN according to another embodiment of the present invention.

A coordinator may repeatedly transmit beacons according to predetermined intervals. The beacon may include location information of the coordinator, information of a total number of time slots and a number of currently used time slots. An operation of periodically transmitting a beacon by a coordinator is described in the following.

The coordinator may reserve, at a predetermined value, a total number of time slots when a time slot is initialized in operation 801, and may scan a time slot for each beacon, thereby generating a bitmap related to use or non-use of the time slot in operation 802.

The coordinator may exclude the time slot from occupied time slots and update a number of occupied time slots when the time slot remains unused for more than a predetermined period of time in operation 803, and may maintain information for allocating a time slot by including, in a beacon, a total number of time slots, a number of currently occupied time slots, and information for identifying a location of a current coordinator, and broadcasting the beacon in operation 804.

The coordinator may determine a release of the occupied time slots when the time slot is in a state of non-use during a period of time in which a communication node moves out of a coordinator region or when the time slot is in a state of non-use during a predetermined number of scanning times based on a beacon interval.

A communication node may perform a scheme of increasing time for collecting beacon information based on whether a beacon is received. An example of determining a time for collecting a beacon by the communication node is as below.

In operation 805, the communication node may determine a collection time, and perform an operation of receiving a beacon during the collection time. The collection time may be two times a value obtained by multiplying a length of a time slot by a maximum number of time slots provided by a wireless network.

The communication node may collect a beacon twice during a collection time when no beacon exists, may collect a beacon during four times the collection time when a beacon remains impossible to be collected, and may suspend a reception during a sleep time and then continue to collect a beacon when a beacon remains impossible to be collected.

When multiple beacons are collected in operation 806, the communication node may select a beacon having a highest priority for location information in operation 807.

In operation 808, the communication node may select time slots as a first, second, and third priority of candidates using a hash function based on an identifier to determine candidates for a time slot to be used, and may increase a number of hash functions and candidates for a time slot, as necessary.

When the identifier corresponds to a resident registration number, the communication node may determine a location of a time slot of the communication node corresponding to an identifier IDi to be s1=IDi mod Lts when the time slot corresponds to the first priority, s2=(IDi*IDi) mod Lts when the time slot corresponds to the second priority, and s3=(IDi*IDi*IDi) mod Lts when the time slot corresponds to the third priority.

In operation 809, the communication node may verify candidates for a time slot to be used during a single beacon interval, and select and use a time slot as per priority from among vacant time slots.

In operation 810, the communication node may attempt to transmit a data frame during a time interval for a selected time slot. In operation 811, the communication node may maintain a network connection by periodically transmitting a data frame.

When a data transmission fails in operation 812, the communication node may store failure information in operation 813.

The communication node may determine whether a maximum time of stay is over in operation 814, and may transmit failure information while a time slot is distributed and recognize a release from the network in operation 815 when the maximum time of stay is determined to be over.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A coordinator comprising:
a scanner to scan a time slot in response to an occurrence of a beacon, thereby generating a bitmap related to use or non-use of the time slot;
an update unit configured to classify the time slot as a non-occupation group and update a number of occupied time slots associated with the non-occupation group when the bitmap related to non-use is generated successively within a predetermined period of time; and
a transmitter to broadcast, to a communication node, information that is for allocating a time slot and includes the updated number of occupied time slots.

2. The coordinator, further comprising:
an initialization unit configured to reserve, at a predetermined value, a total number of time slots when the time slot is initialized,
wherein the transmitter includes the total number of time slots in the information and broadcasts the information further including the total number of time slots.

3. A communication node comprising:
a connector to connect to a communication node moving into a coordinator region by performing an operation of receiving a beacon during a predetermined collection time; and
a controller to transmit a data frame to the communication node, and to control the connector to maintain the connection when the communication node permits reception of the transmitted data frame or to release the connection when the communication node rejects reception of the transmitted data frame.

4. The communication node of claim 3, wherein the connector comprises:
a collector to collect a beacon transmitted by a coordinator;
a determining unit configured to determine candidates for a time slot to be used based on information that is for allocating a time slot and is included in the collected beacon; and
an allocating unit configured to allocate a time slot to which the communication node connects based on an order of priority from among the determined candidates for a time slot.

5. An operating method by a coordinator, the method comprising:
scanning a time slot in response to an occurrence of a beacon, thereby generating a bitmap related to use or non-use of the time slot;
classifying the time slot as a non-occupation group and updating a number of occupied time slots associated with the non-occupation group when the bitmap related to non-use is generated successively within a predetermined period of time; and
broadcasting, to a communication node, information that is for allocating a time slot and includes the updated number of occupied time slots.

6. The method of claim 5, further comprising:
reserving, at a predetermined value, a total number of time slots when the time slot is initialized,
wherein the broadcasting comprises including the total number of time slots in the information and broadcasting the information further including the total number of time slots.

7. The method of claim 5, further comprising:
determining a release of the occupied time slots when the time slot is in a state of non-use during a period of time in which the communication node moves out of a coordinator region or when the time slot is in a state of non-use during a predetermined number of scanning times based on a beacon interval.

8. An operating method by a communication node, the method comprising:
receiving a beacon during a predetermined collection time;
determining candidates for a time slot to be used based on information that is for allocating a time slot and is included in the collected beacon;
attempting to transmit, to each time slot included in the determined candidates, a data frame based on an order of priority; and
connecting to a time slot receiving the data frame via a network.

9. The method of claim 8, wherein, when received beacons are plural, the determining comprises selecting a single beacon having a highest priority for location information from among the plurality of beacons, and determining candidates for a time slot to be used in association with the single selected beacon.

10. The method of claim 8, wherein the receiving comprises setting, to the predetermined collection time, two times a value obtained by multiplying a length of a time slot by a maximum number of time slots provided by a wireless network.

11. The method of claim 8, wherein, when the beacon is not received during the predetermined collection time, the receiving comprises re-receiving the beacon by adjusting the predetermined collection time to n-times the predetermined collection time, the n corresponding to two or four.

12. The method of claim 8, wherein the determining comprises determining the candidates in order of priority of the candidates using a hash function based on an identifier.

13. The method of claim 8, wherein the determining comprises:
determining, as a first priority of the candidates, a first time slot at a location of “identifier mod a total number of time slots”;
determining, as a lower priority of the candidates in comparison with the first time slot, a second time slot at a location of “identifier*identifier mod a total number of time slots”; and
determining, as a lower priority of the candidates in comparison with the second time slot, a third time slot at a location of “identifier*identifier*identifier mod a total number of time slots”.

14. The method of claim 8, further comprising:
storing failure information when no time slot receives the data frame during a maximum time of stay; and
recognizing a release from the network in response to the storing of the failure information.
